(19) United States
(12) Patent Application Publication
(10) Pub. No.: US 2014/0307694 A1
(43) Pub. Date: Oct. 16, 2014

(54) Uplink Transmissions and Grants in Extension Carrier

(71) Applicant: Broadcom Corporation, Irvine, CA (US)

(72) Inventors: Erlin Zeng, Beijing (CN); Jing Han, Beijing (CN); Chunyan Gao, Beijing (CN); Haiming Wang, Beijing (CN); Wei Hong, Beijing (CN); Wei Bai, Beijing (CN); Shuang Tan, Beijing (CN)

(21) Appl. No.: 14/356,429

(22) PCT Filed: Nov. 7, 2011
(86) PCT No.: PCT/CN2011/081882

§ 371 Date: May 6, 2014

(51) Int. Cl. H04W 72/04

(52) U.S. Cl. CPC H04W 72/042
USPC 370/329

(57) ABSTRACT

A user equipment UE is configured with an integer value N which defines an effective data rate. The network sends to the UE a grant for uplink transmissions that comprises a resource indication field that allocates N channels each having a same predetermined uplink format and payload capacity. The UE sends N bit sequences on the respective N channels, each bit sequence comprising data and the same predetermined uplink format. In various embodiments: the network specifically configures the UE to receive the predetermined format of the grant; the grant may have an indicator whether the channels are for new data and for the MCS to use; the N channels may be in a same or in adjacent sub frames regardless of the value of N; and there is one MAC header for all the N channels which the network reads as a single MAC PDU.

### TECHNICAL FIELD

The exemplary and non-limiting embodiments of this invention relate generally to wireless communication systems, methods, devices and computer programs, and more specifically relate to arranging uplink transmissions and resource grants in an extension carrier of a wireless communication system which utilizes carrier aggregation to organize it radio spectrum.

### BACKGROUND

The following abbreviations that may be found in the specification and/or the drawing figures are defined as follows:

3GPP third generation partnership project

ACK acknowledge/acknowledgment

CA carrier aggregation

CC component carrier

CRC cyclic redundancy check

CRS common reference signal

DCI downlink control information

DL downlink

eNB node B/base station in an E-UTRAN system

E-UTRAN evolved UTRAN (LTE)

FDD frequency division duplex

LTE long term evolution (of UTRAN)

LTE-A long term evolution-advanced

MAC medium access control

MCS modulation and coding scheme

NACK negative acknowledge/negative acknowledgment

PCell primary component carrier/primary cell

PDCCH physical downlink control channel

PDSCH physical downlink shared channel

PDU protocol data unit

PRB physical resource block

PUCCH physical uplink control channel

PUSCH physical uplink shared channel

RRC radio resource control

SCell secondary component carrier/secondary cell

SPS semi-persistent scheduling

TBCC tail-biting convolutional coding

TDD time division duplex

UE user equipment

UL uplink

UTRAN universal terrestrial radio access network

The concept of carrier aggregation CA is well established in the wireless communication arts and has been undergoing development for the LTE/LTE-A systems. In CA the whole system bandwidth is carved into multiple component carriers CCs. Specific for LTE/LTE-A, each UE is to be assigned one PCell which remains active and one or more SCells which may or may not be active at any given time, depending on data volume for the UE and traffic conditions in the serving cell. At least one CC in the system is to be backward compatible with UE's which are not capable of CA operation.

The structure of the extension carrier is not yet determined; it may or may not have a control channel region, it may have only an abbreviated control channel region or it may have a full set of channels so as to be backward compatible with LTE Release 8. In any case the structure is under development for LTE Release 11 and some enhancements to the UL may be possible, particularly to better facilitate machine-type communications on such an extension carrier.

FIG. 1 illustrates the general CA concept for LTE/LTE-A. For a given UE there is assigned a PCell 100 which by example is backward-compatible with LTE Release 8/9 UEs (and therefore 20 MHz in bandwidth though the various CCs may be defined by different bandwidths). That same UE may also have in its assigned set SCell#1, SCell#2 and SCell#3, which for completeness SCell#3 is shown as being non-contiguous in frequency with the other CCs. Any number of the SCells or none of them may be active for that UE at any given time, as coordinated with the eNB. Every UE is to have its assigned PCell always active, and so legacy UEs which are not CA-capable will be assigned one backward-compatible CC and no others.

These teachings relate the UL design of an extension carrier, consistent with the request for proposals set forth the 3GPP TSG RAN meeting 352 (see RP-11073; Update to LTE Carrier Aggregation Enhancements WTD; Bratislava, Slovakia; 31 May-3 Jun. 2011). That request seeks to study additional carrier types including non-backwards compatible elements for CA. Relatedly, the 3GPP RAN1 meeting #66bis (Zhuhai, China; 10-14 Oct. 2011) set forth some working assumptions for the new carrier type for CA; namely it is to enhance spectral efficiency, improved support for heterogeneous network deployments (macro and pico/femto cells), and it should be energy efficient. More particularly, there is to be at least one new carrier type in LTE Release 11 with at least reduced or eliminated legacy control signaling and/or CRS at least for the downlink (or for TDD, the downlink subframes on a carrier), and associated with a backward compatible carrier. For FDD a downlink carrier of the new type may be linked with a legacy uplink carrier, and for TDD a carrier may contain downlink subframes of the new type and legacy uplink subframes.

There is also the possibility that machine-to-machine (M2M) type communications (infrequent very small packets) might be efficient on the yet to be developed carrier. See for example document R1-112893 by Huawei and HiSilicon, entitled ADDITIONAL CARRIER TYPES—MOTIVATIONS AND ISSUES (3GPP TSG RAN1 meeting #66bis; Zhuhai, China; 10-14 Oct. 2011).

Still another document R1-113072 by Samsung entitled Enhancing. PDCCH Capacity for CA through Compact DCI Formats (3GPP TSG RAN1 meeting #66bis; Zhuhai, China; 10-14 Oct. 2011) describes a compact DCI design for UL grant in which the DCI size is reduced by a) limiting the size of the PUSCH; b) making unavailable a portion of the UL bandwidth; and c) limiting the available MCS options. These solutions are still based on PUSCH assignments and so are not seen to be related to these teachings.

As further background, consider the conventional LTE system UL. There are logical channels PUCCH and PUSCH, each with different multiplexing capacity and supported payload sizes. For example, the PUSCH can support various transport block sizes and therefore various data rates, but it has a low multiplexing capacity even with uplink multi-user MIMO. The PUCCH can support better multiple user multiplexing but the payload size is limited; for example PUCCH format 1b supports a 2 bit payload size and a maximum of 18 UEs multiplexed in a PRB whereas PUCCH format 3 support a 20 bit payload size and a maximum of 5 UEs multiplexed in a PRB.

In the inventors' view the above conventional signal formats do not provide a good balance between multiplexing and payload size, at least not a balance that would be optimal for the new extension carrier. These teachings provide a new uplink design for such an extension carrier of a CA system.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: configure a user equipment with an integer value N which defines an effective data rate; send to the user equipment a grant for uplink transmissions, the grant comprising a resource indication field that allocates N channels each having a same predetermined uplink format and payload capacity; and receive from the user equipment N bit sequences on the respective N channels, each bit sequence comprising data and the same predetermined uplink format.

In a second exemplary embodiment of the invention there is a method comprising: configuring a user equipment with an integer value N which defines an effective data rate; sending to the user equipment a grant for uplink transmissions, the grant comprising a resource indication field that allocates N channels each having a same predetermined uplink format and payload capacity; and receiving from the user equipment N bit sequences on the respective N channels, each bit sequence comprising data and the same predetermined uplink format.

In a third exemplary embodiment of the invention there is a computer readable memory tangibly storing a computer program executable by at least one processor, the computer program comprising: code for configuring a user equipment with an integer value N which defines an effective data rate; code for sending to the user equipment a grant for uplink transmissions, the grant comprising a resource indication field that allocates N channels each having a same predetermined uplink format and payload capacity; and code for receiving from the user equipment N bit sequences on the respective N channels, each bit sequence comprising data and the same predetermined uplink format.

In a fourth exemplary embodiment of the invention there is an apparatus comprising at least one processor and at least one memory storing a computer program. In this embodiment the at least one memory with the computer program is configured with the at least one processor to cause the apparatus to at least: determine a user equipment configuration comprising an integer value N which defines an effective data rate; receive from a network node a grant for uplink transmissions, the grant comprising a resource indication field that allocates N channels each having a same predetermined uplink format and payload capacity; and send to the network node on the respective N channels N bit sequences, each bit sequence comprising data and the same predetermined uplink format.

In a fifth exemplary embodiment of the invention there is a method comprising: determining a user equipment configuration comprising an integer value N which defines an effective data rate; receiving from a network node a grant for uplink transmissions, the grant comprising a resource indication field that allocates N channels each having a same predetermined uplink format and payload capacity; and sending to the network node on the respective N channels N bit sequences, each bit sequence comprising data and the same predetermined uplink format.

In a sixth exemplary embodiment of the invention there is a computer readable memory tangibly storing a computer program executable by at least one processor, the computer program comprising: code for determining a user equipment configuration comprising an integer value N which defines an effective data rate; code for receiving from a network node a grant for uplink transmissions, the grant comprising a resource indication field that allocates N channels each having a same predetermined uplink format and payload capacity; and code for sending to the network node on the respective N channels N bit sequences, each bit sequence comprising data and the same predetermined uplink format.

These and other embodiments and aspects are detailed below with particularity.

### BRIEF DESCRIPTION OF THE DRAWINGS

FIG. 1 is a schematic frequency diagram showing a carrier aggregation system in which some component carriers lay in a licensed band and some lay in unlicensed bands.

FIGS. 2A-B illustrate prior art mappings of the LTE Release 10 PUCCH format 3 using time division duplexing.

FIG. 3 is a schematic illustration of DCI format according to an exemplary embodiment of these teachings.

FIG. 4 is a high level logic flow diagram that illustrates actions taken by the eNB and by the UE according to an exemplary embodiment of these teachings.

FIG. 5 is a schematic diagram of a physical layer processing chain in the UE according to an exemplary embodiment of these teachings.

FIG. 6 is a logic flow diagram that illustrates from the perspective of the network/eNB the operation of a method, and a result of execution of computer program instructions embodied on a computer readable memory, in accordance with an exemplary embodiment of this invention.

FIG. 7 is a logic flow diagram that illustrates from the perspective of the network/eNB the operation of a method, and a result of execution of computer program instructions embodied on a computer readable memory, in accordance with an exemplary embodiment of this invention.

FIG. 8 is a simplified block diagram of a UE and an eNB which are exemplary electronic devices suitable for use in practicing the exemplary embodiments of the invention.

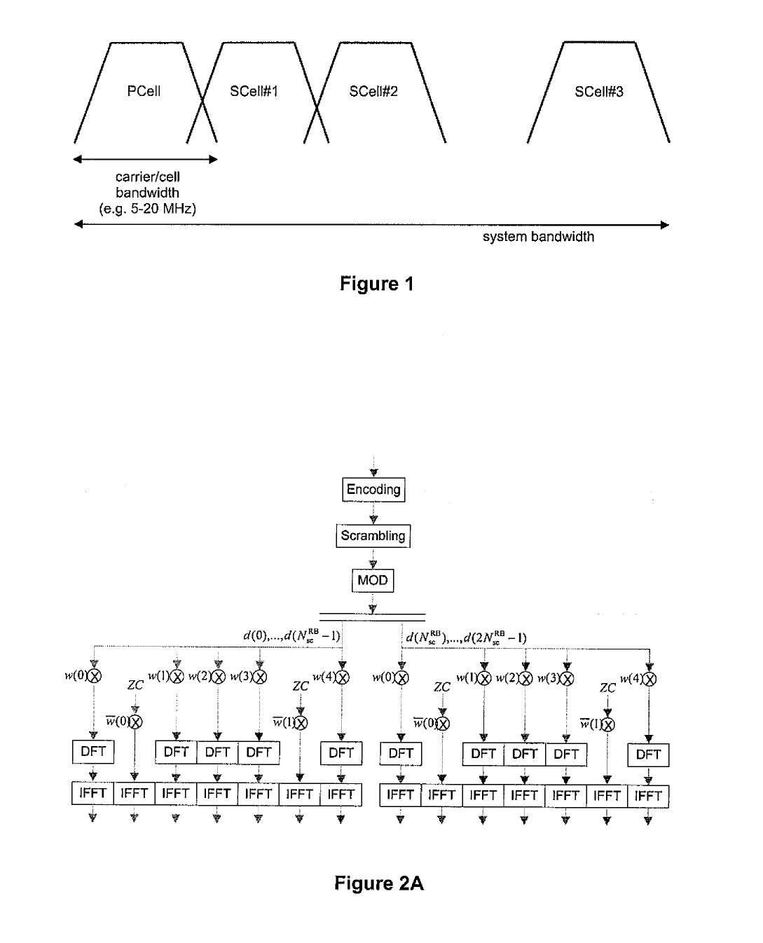

### DETAILED DESCRIPTION

The following examples are in the specific context of the LTE/LTE-A systems (for example, Release 11 and later)but these teachings are more broadly applicable to any wireless radio system which divides its spectrum into different component carriers and which further employs radio resource grants from the network to the UEs. These examples consider only a single UE but it will be understood the description applies for all such UEs being scheduled and sending UL data according to the teachings described for one UE. Additionally, these teachings may be further extended to a machine-to-machine (M2M) type device, such as for example a fixedly mounted traffic reporting device, which uses machine-type communications on the extension carrier described herein, with or without any other component carriers configured for that device. Such machine-to-machine type device is included under the more generic term UE or user device to distinguish it from any network node.

As will be detailed below there is presented a new design for UL signaling in a component carrier that allows better such balance between multiplexing and payload size and which exhibits reasonable complexity. When the number of low-data rate UEs becomes large in a system (whether conventional UEs, those engaging in machine-type communications, or some combination thereof), the control overhead from conventional LTE uplink grants will be high. In that regard embodiments of these teachings also provide a reduced size for the grant of the UL resources as is detailed below. So while the UL resources according to these teachings improve resource efficiency and flexibility for UEs with smaller packet or lower uplink data rates, the grants of those resource offer a reduced uplink grant overhead (or equally a reduced DCI size) for the case of a large number of users.

Some design considerations inherent in the below teachings include that the design for this component carrier is format-friendly to other conventional LTE release 11 UL transmissions and so easily incorporated into that system, for example by not fragmenting PRBs. For machine-type communications there is low additional complexity at the network side and at UE side, since portions of the conventional component carrier structure is re-used in these teachings. As will be seen the UL data rate is easily controllable by the network, and the flexible resource allocation saves on MAC header overhead particularly for the case of small data packets.

These teachings may be conveniently divided into two main portions, those relating to the UL data transmissions from the UE to the network, and those related to the network's DL grant of those resources to the UE. First consider the UL resources which are allocated to the UE. For a given UL subframe there are to be N channels assigned/allocated to a UE. Each of these channels has the same pre-determined UL format, by example the LTE PUCH format 3 or format 3a. Note that this is the format only, what the UE sends on these allocated PUCCH format 3 channels is user data, as opposed to conventional LTE in which control signaling is sent using PUCCH format 3. Other UL formats may be substituted, providing the same UL format is used for each of the N UL allocations/channels and the payload bit-size of the predetermined UL format is fixed and not changeable by the eNB to accommodate a larger or smaller number of bits (the data rate may be changed by changing the MCS but this does not change the bit-size of the payload). In this case N is a positive integer, which can be predefined via higher layers or indicated to the UE via layer 1 (L1) control signalling. Setting the value of N is the mechanism by which the network can control the data rate for any given UE; for very low data rates the network may set N=1 for a UE and for a greater data volume the network can increase the rate by increasing the value of N.

The UE then transmits its data as N PUCCH format 3 signals in the UL subframe. For convention assume that B1, B2, . . . , B_N are the bit sequences (after channel encoding and rate matching) which the UE transmits on the respective N channels (since PUCCH is a logical channel these may be referred to as N PUCCH channels despite that they carry user data). There are two embodiments the UE may choose from. If the UE chooses to use separate channel coding for the different bit sequences it will transmit B1, B2, . . . , B_N without a CRC attachment; if the UE chooses to use joint channel coding for the different bit sequences it will transmit B1, B2, . . . , B_N with a CRC attachment.

In any case the UE will append a single MAC header to the N PUCCH channels so that the data transmitted over all the channels share the same MAC header. This allows the MAC layer in the eNB which receives the N PUCCH channels to treat them as a single MAC PDU. This obviously saves signaling overhead to the extent N is greater than one.

Specific to the PUCCH format 3, it has a multiplexing capacity of five, meaning the network can schedule up to five UEs for the same PRB if each UE uses only one of the PUCCH format 3 channels. Various combinations are also possible, for example if three UEs are multiplexed in a single PRB, with two of them using two PUCCH format 3 channels and one of them using one PUCCH format 3 channel. Different types of uses can also be multiplexed, for example 2 UEs can be multiplexed to the same PRB where a UE exploiting these teachings is granted N=4 PUCCH format 3 channels for its data and a legacy UE which transmits ACK/NACK is given the remaining one PUCCH format 3 channel. Thus these uplink principles are readily compatible with the existing LTE system with little or no adaptation needed to accommodate the legacy users.

The PUCCH format 3 also has a maximum payload of 20 bits (using dual rate-matching RM encoding as supported by the time division duplex implementation of carrier aggregation in the LTE system).

In one specific implementation there is a baseline mode of N=1, meaning that in the absence if signaling a value for N the network will assign and the UE will assume there is only one PUCCH format 3 resource for the UE to transmit 20 bits per subframe. This equals a data rate of 20 kbps, which is viable so long as packet delay is not an issue (since for example a 100 type packet would take 40 ms to finish at this data rate). When a higher data rate is required, a larger number of N resources can be assigned to a UE as is detailed above for the B1, B2, . . . , B_N bit sequences. So by doubling the value of N for the granted PUCCH format 3 channels the network can double the UE's data rate, and so forth. If the network allocates to the UE N=5 channels in a PRB, the data rate is then 100 kbps. In case the UE's data needs exceed that which the maximum N value can provide according to these teachings (N=5 being only an example maximum and not limiting), the network can simply schedule the eNB with a conventional PUCCH which allocates conventional PDSCH resources in the LTE system.

Thus the data rate is controllable via the changeable value for N. The above examples assume a fixed modulation scheme is used as in the existing PUCCH format 3. As will be detailed below with the grant the MCS is also changeable which can be used to increase the data rate further, for example if 16QAM modulation is used instead of QPSK the supported data rate can be doubled without any changes to the value of N.

In the above description it was stated the N PUCCH format 3 channels are transmitted by the UE in the same subframe. This is a non-limiting example; following summarize various ways in which the N PUCCH format 3 channels may be dispersed in the radio frame in various embodiments of these teachings:
One or multiple enhanced PUCCH format channels (for example to support payload size greater than PUCCH format 3) are transmitted in the same subframe from a UE;
Multiple PUCCH format 3 channels are transmitted in multiple adjacent subframes from a given UE (then in each subframe it can be that only one PUCCH channel is transmitted from the UE), and these multiple channels are scheduled by the same DCI resource grant; or
Any combination of the above two options.

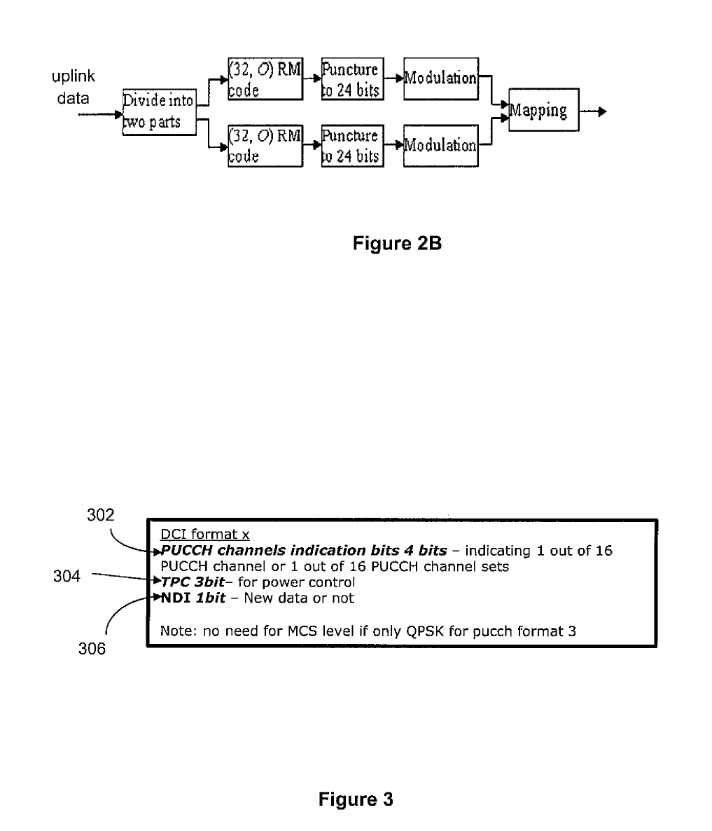

FIGS. 2A-B illustrates how the PUCCH Format 3 is operated on in the LTE system. In particular embodiments of these teachings the same Format 3 structure is employed for data as is shown at FIG. 2B, as opposed to the ACK/NACK signalling as in conventional LTE Release 10. Keeping the discrete Fourier transform DFT and inverse DFT processing the same (as well as scrambling) enables the added benefit that PUCCH signalling of data according to these teachings can be multiplexed with conventional PUCCH signalling of conventional ACK/NACK messages because the code division multiplexing structure is maintained. In this manner these teachings are more readily implemented in a practical system which must service both new and legacy UEs.

Now consider the UL grant which the network sends DL and which allocates those N PUCCH format 3 channels to the UE. This grant has a different format than other conventional DCIs in the LTE system, which is termed herein for convenience as Format X, or more generally referred to as a predetermined grant format. FIG. 3 presents an example of such a predetermined grant format/Format X for allocating to the UE the UL resource(s).

There is a resource indication field 302 which comprises M bits to indicate the N PUCCH format 3 channels. M is a positive integer and is predefined or configured via higher layers. These M bits can be used to directly indicate the N PUCCH format 3 resources, or can be used to indicate N resources based on some predefined or higher layer configured resource combinations.

Not shown at FIG. 3 is a MCS indicator field. This field is present in certain deployments where variable MCS is configured in the network for the allocated N PUCCH channels, and is not present in others where only one (default) MCS is employed for the allocated N PUCCH channels. For example, MCS flexibility can be configured ON/OFF via higher layers, and so the MCS field may be as short as a single bit if only two MCSs are viable options (or more than one bit if there are more than two MCS options for the network). When the MCS indicator is configured as ON, then UE assumes there will be a MCS indicator field present in any DCI Format X the UE receives, and the modulation coding scheme the UE is to use in the uplink transmissions on the N PUCCH format 3 channels will be as indicated by the MCS field. In this manner the MCS can be dynamically changed by the network once it is turned ON to better adapt to changing channel conditions and achieve higher throughput (the shift from OFF to ON may be only semi-statically configurable).

Furthermore, higher orders of MCS than PUCCH format 3 can effectively decrease the required number of PUCCH channels needing to be allocated to a given UE, and therefore reduce the length of the resource allocation indicator 302 in the DCI format X resource grant, which also reduces scheduling complexity and potentially the high peak-to-average power ratio encountered when multiple sub-bands are allocated to one UE. Since multiple UEs within a PRB are multiplexed using time domain orthogonal codes, using a different modulation scheme will not impact the multiple user multiplexing.

If the MCS indication field is configured as OFF, the UE will assume this field is not included in the DCI format X as is the case for FIG. 3, and the UE will use a fixed modulation coding scheme for its UL transmissions on the allocated N PUCCH format 3 channels.

The predetermined grant format of FIG. 3 further includes transmission power control TPC bits 304, which indicate the transmission power for the UE to use on when sending its data on the allocated N PUCCH format 3 channels. And finally there is a new data indicator (NDI) 306 which indicates whether or not the allocated N PUCCH format 3 resources are for new data/new transport block.

Also not shown at FIG. 3 is a CRC field, which is conventional to the PDCCH of earlier LTE releases. Namely, for the case in which the eNB is sending the predetermined grant format X of FIG. 3 to only one UE, the eNB will scramble the CRC field with the UE's identity. If instead the eNB is sending the predetermined grant format X of FIG. 3 to multiple UEs, those UEs will be grouped and the group will be assigned an identifier by the network and so the eNB will scramble the CRC field for the group-directed format X grant with the group identity.

The format X grant when dedicated to a single UE (e.g., its CRC is scrambled with the UE's ID) is most suitable for the case the format X DCI is relatively large (multiple PUCCH format 3 channels being allocated). When the uplink grant payload size is small, it is possible to multiplex multiple users' uplink grants in the same format X DCI (scramble the CRC field with a group ID), which in this case may be similar to DCI format 3/3a used for power control in the conventional LTE system.

While FIG. 3 illustrates M=4 bits for the resource indication field 302, this is simply a non-limiting example. Assuming there are exactly 4 bits available in this field 302, that means the field can indicate one out of a total of sixteen possible PUCCH channels, or one channel set out of a total of sixteen PUCCH channel sets. If the M bits indicate a PUCCH set with NPUCCH format 3 resources, then the user will transmit on the N PUCCH channel accordingly. The bit counts other than M=4 are possible to allow a balance between DCI overhead and resource flexibility. Since PUCCH format 3 is used in this example, there is no need to signal the MCS level, which saves the control overhead. When a CRC is attached after the channel coding of the grant, retransmission is possible if a packet error is detected by the eNB which sent it.

This Format X grant is different from any other of the conventional LTE DCI formats for the LTE PDCCH, specifically it is quite a bit smaller. So prior to sending any Format X grants to the UE, the network configures the UE via higher layers which DCI format(s) it shall monitor for its uplink grants. For example, the network can configure the UE to monitor for any one of the following at any given time:
Format X only;
conventional uplink DCI formats (e.g., DCI format 0 and DCI format 4 in LTE Release 10);
both Format X and the conventional uplink DCI formats; or
none of the above DCI formats, but instead the UE is configured to only transmit uplink signals based on a predefined periodicity and some predefined PUCCH or PUSCH channels.

For example, if the UE is only configured to monitor the DCI Format X, the UE is not required to monitor any other DCI/uplink grant formats for an allocation of a PUSCH. This option is most advantageous for the UEs with only a low data rate or small packets in the uplink. This option reduces the total number of PDCCH candidates the UE needs to monitor, and thus results in a lower detection complexity for the UE since it will have less blind decodings to perform in order to see if its identity was used to scramble the CRC of the PDCCH. At the same time, for high data rate UEs which are configured to monitor only the conventional DCIs, that configuration will exclude them from monitoring the new DCI Format X and thereby not increase their own blind detection burden as compared to current LTE practice. If for some UEs the blind detection complexity is not an issue, the eNB can configure such UEs to monitor all the DCI Formats to provide the network with maximum flexibility for scheduling those UEs.

The final entry in the above four bullets is for the network to configure the UE so that it is not required to monitor any of the above dynamic DCI format signaling. Instead this configuration allocates to the UE UL resources for it to transmit its UL data according to a predefined periodicity and some predefined PUCCH or PUSCH channels. In this manner it may also be considered a resource grant, just not of the Format X variety though it may be considered that the periodically repeating UL resources make up N channels and the UE may be required in this case also to transmit its data in the PUCCH format 3. This option is most suitable for some non-delay sensitive and stable traffic types.

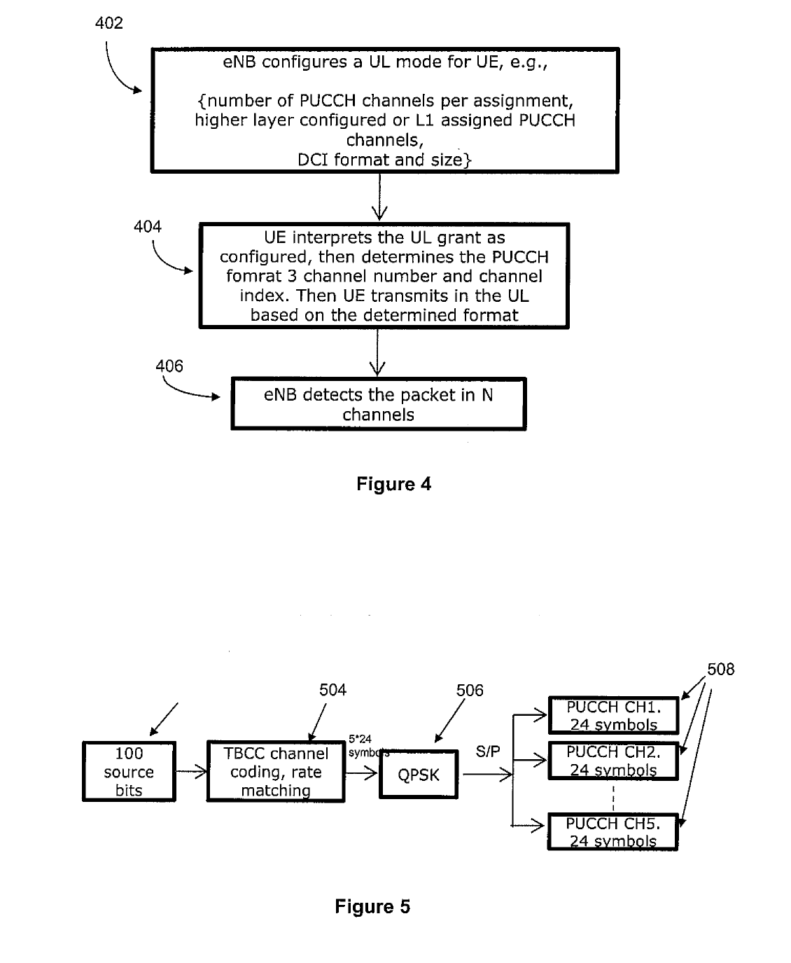

FIG. 4 is a logic flow diagram illustrating a high level overview of the entire process for using the UL resources. At block 402 the eNB configures an UL mode for a UE, such as instructing it via L1 signaling to monitor for one or more specific types of DCI (including format X in these examples), the number of PUCCH format 3 channels it will receive per grant, the size of the DCI, and whether MCS is turned ON or OFF for this UE.

The UE at block 404 interprets the UL format X grant it receives according to its configuration from block 402. From the grant itself the UE determines the PUCCH format 3 channel numbers and index, then transmits according to the determined format (MCS, joint coding, CRC all as detailed above). Then at block 406 the eNB receives the N data sequences on the N PUCCH format 3 channels.

More specifically, when the Format X is configured for the UE the eNB can decide the value of N based on each UE's traffic type and their respective required data rate. For example, if we assume the UE is transmitting in every uplink subframe using N PUCCH format 3 channels (20 bits payload size), and ignoring the possibility of retransmission, its data rate will be N*20 bps. Then the eNB configures the value of N for each UE.

The eNB will then determine the DCI payload size for DCI Format X. For example, the eNB may decide the value of M (the length of the resource indication field 302) based on some tradeoff between resource flexibility and DCI overhead. Once the DCI size is determined, the eNB will indicate the DCI size (or the value of M) to a UE via the higher layer configuration. Then finally the eNB can transmit the Format X uplink grant to the UE to schedule its uplink data.

Once the eNB receives the UE's UL data, it will try to decode the N PUCCH format 3 channels as scheduled, to see if an uplink packet can be correctly detected. A retransmission can be scheduled if packet error is detected when the eNB checks the CRC.

FIG. 5 an example of a UE processing chain which assumes N=5 and that TBCC is used for the channel encoding. In this example, the source bits are input at 502 and coded at 504 to match the UL data rate, then modulated at 506 with QPSK. The modulated symbols are serial to parallel converted into N=5 parallel sequences 508 to be transmitted in the allocated 5 PUCCH format 3 channels. Since the TBCC encoding (decoding) is already part of the user (and eNB) implementation in LTE Releases 8/9/10, there is no extra complexity to implement this particular example of these teachings. There is some extra processing in the rate matching and the serial to parallel conversion but this is seen to be minimal and simple to implement even in legacy UEs and eNBs, possibly even via a software update.

Note that FIG. 5 illustrates only the physical layer processing. Respecting the MAC layer processing, a single MAC header is appended to all the information bits (i.e., the data transmitted over all channels share the same MAC header) to save MAC overhead as was detailed above. For example, when N=5 up to 100 bits can be transmitted in a given subframe and if among these bits there are 3 bytes (=24 bits) used for the MAC header, the relative MAC header overhead is around 24%. When the number of PUCCH channels shares the same MAC header, the relative MAC header overhead does not increase for the fact that more channels are being used as would be the case in conventional LTE.

The above specific examples are non-limiting; and now are presented certain expansions of these teachings over the above examples. As already noted, all of the N PUCCH format 3 channels need not be in the same subframe. Instead of the PUCCH format 3 there may instead be an enhanced PUCCH format which has a greater payload size than the 20 bits of format 3, increasing the data rate the system supports.

Multiple PUCCH format channels may be transmitted in multiple adjacent subframes from a given UE. For example, in each subframe there may be only one PUCCH channel transmitted from that UE, and these multiple channels are scheduled by the same DCI as was noted above. This also realizes an overhead reduction in that the data in the multiple consecutive subframes can be jointly encoded and can also use the same CRC field to further avoid any extra CRC overhead. And also as detailed above these multiple data sequences on different channels can also share the same MAC header to reduce the MAC header overhead, which is especially relevant for small packet cases which machine-type communications are expected to use extensively. One advantage of distributing the UE's transmissions among multiple consecutive subframes is to balance the PUCCH overhead in the time domain, since this option avoids using too many PUCCH resources in only a subset of subframes. This is a tradeoff though, for on the UE side its UL transmitter is expected to be tuned to a larger number of UL subframes. The eNB can find a proper balance via its configuration of the UE.

Embodiments of the invention detailed above provide certain technical effects such as for example offering low additional complexity since Format 3 PUCCH and TBCC are all existing functions in LTE Release 10. Additionally there is no extra encoding or decoding scheme required to implement these teachings. Embodiments of these teachings offer good co-existence of new UEs practicing these teachings with conventional LTE Release 11 terminals which may not yet be compatible. The PUCCH format 3 for the new UL design is thus friendly for UEs which use the PUCCH format 3 conventionally for ACK and NACK signaling, and there are a variety of multiplexing options that are easy to implement and efficient from a resource utilization point of view.

Further technical effects are the controllable data rate, controllable by the eNB's allocation of different numbers N of PUCCH format 3 channels per transmission time interval TTI (flexible between 20 and 100 kbps data rate if fixed modulation); and also controllable by a dynamically controllable MCS when the Format X grant includes a MCS field. These are all configurable per UE and need not be cell-wide.

Still additional technical effects include a smaller size for the uplink grant, and possibly multiple UE's PDCCH multiplexed in a single DCI. The TBCC with CRC allows retransmissions, so there is no need for any new hybrid automatic repeat request design or mapping for retransmissions. And finally there is a lower MAC header overhead due to sharing one MAC header among multiple data sequences on multiple PUCCH format 3 channels.

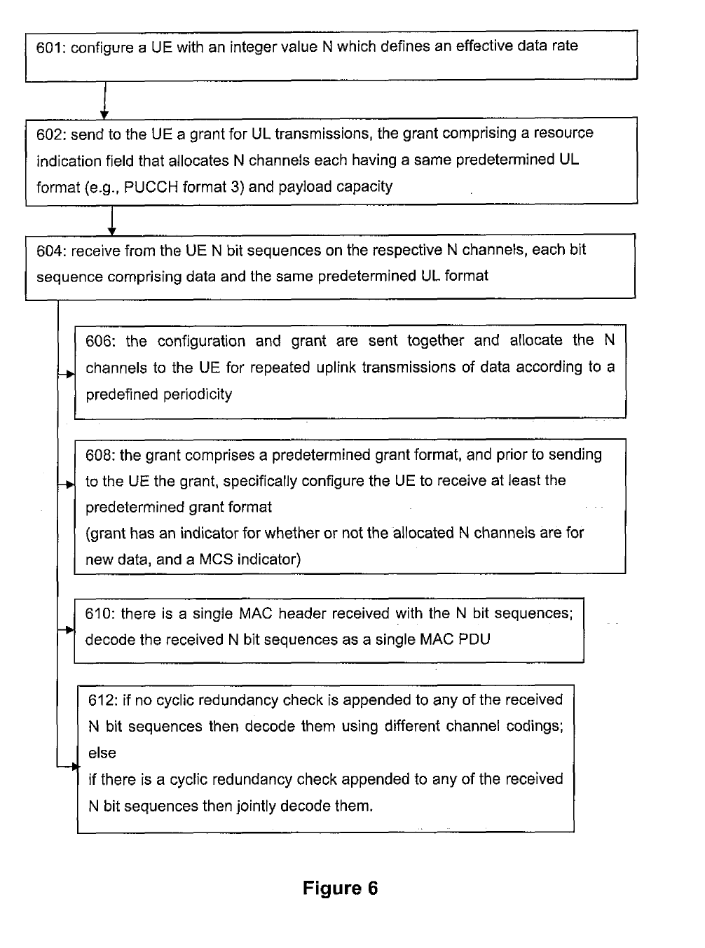

Now are detailed with reference to FIG. 6 further particular exemplary embodiments from the perspective of the network/eNB. FIG. 6 may be performed by the whole eNB, or by one or several components thereof such as a modem. At block 601 the network configures a UE with an integer value N which defines an effective data rate. This is because the payload capacity of the PUCCH format 3 channels is fixed. In one embodiment there is a default value of N=1 in which case the network configures the UE with N=1 by not explicitly changing that default value. The network can configure the UE with different values for N by signaling such as for example L1 signaling. At block 602 the eNB sends to the UE a grant for UL transmissions, the grant comprising a resource indication field 302 that allocates N channels each having a same predetermined UL format and payload capacity. At block 604 the eNB receives from the UE N bit sequences on the respective N channels, each bit sequence comprising data and the same predetermined UL format.

Further portions of FIG. 6 represent various of the specific but non-limiting embodiments detailed above. Block 606 provides further detail that the grant of block 602 is sent when configuring the UE at block 601 with the value N, and this combined configuration/grant allocates the N channels to the user equipment for repeated uplink transmissions of data according to a predefined periodicity such as on predefined PUCCH or PUSCH resources. Alternatively, block 608 provides that the grant comprises a predetermined grant format, and prior to sending to the UE the grant, specifically configuring the UE to receive at least the predetermined grant format. For the grant of block 608 there is an indicator for whether or not the allocated N channels are for new data, a MCS indicator identifying modulation and coding the UE is to use for the allocated N channels.

Block 610 summarizes the embodiment in which there is a single MAC header received with the N bit sequences; and the received N bit sequences are decoded as a single MAC PDU. And finally block 612 provides the embodiment in which for the case there is no cyclic redundancy check appended to any of the received N bit sequences, the received N bit sequences are decoded using different channel codings; while for the case there is a cyclic redundancy check appended to any of the received N bit sequences the received N bit sequences are jointly decoded.

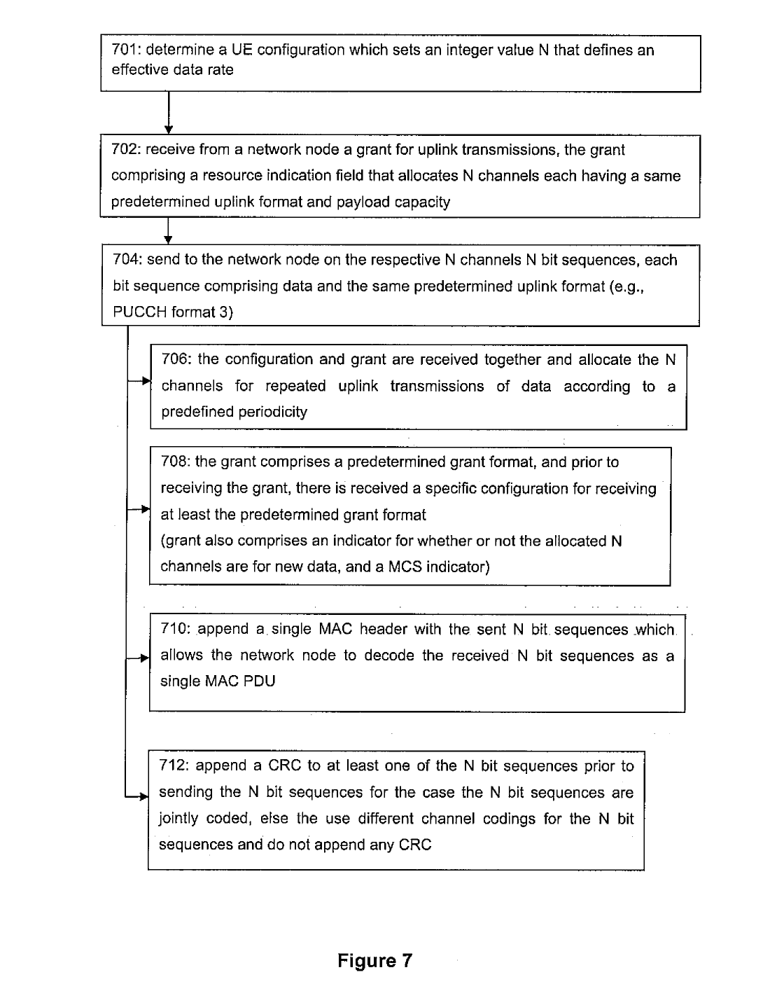

Not shown specifically at FIG. 6 are the embodiments detailed above in which the grant comprises a CRC field which is scrambled by an identifier for the UE, or with an identifier for a group of which the UE is a member; and the embodiments in which the N channels are disposed in a same subframe or in adjacent subframes, regardless of the value N configured for the user equipment. These embodiments also equally for FIG. 7 below.

FIG. 7 summarizes particular exemplary embodiments from the perspective of the UE. FIG. 7 may be performed by the whole UE, or by one or several components thereof such as a modem. At block 701 the UE determines its configuration which gives the integer value N that defines an effective data rate. There may be a default configuration in which N=1 and any other value for N is set by L1 or other signaling received from the network, or the network may configure the N value via signaling in all cases. The value of N sets the effective data rate because the N PUCCH format 3 channels each have a same payload capacity. At block 702 the UE receives from a network node a grant for uplink transmissions, the grant comprising a resource indication field that allocates N channels each having a same predetermined uplink format and payload capacity. At block 704 the UE sends to the network node on the respective N channels N bit sequences, each bit sequence comprising data and the same predetermined uplink format.

Further portions of FIG. 7 reflect some of the non-limiting embodiments detailed above. At block 706 the grant of block 702 is received with the configuration of block 701 for the value N, and that combined configuration/grant allocates the N channels for repeated uplink transmissions of data according to a predefined periodicity, such as on predefined PUCCH or PUSCH channels. Alternatively at block 708 the grant comprises a predetermined grant format, and prior to receiving the grant, there is received a specific configuration for receiving at least the predetermined grant format.

The grant of block 708 may also comprise an indicator for whether or not the allocated N channels are for new data, and a MCS indicator identifying modulation and coding for use with the data sent on the allocated N channels.

Block 710 summarizes the embodiment in which the UE appends a single MAC header with the sent N bit sequences which allows the network node to decode the received N bit sequences as a single MAC protocol data unit PDU.

And finally block 712 provides the embodiment in which the UE appends a CRC to at least one of the N bit sequences prior to sending the N bit sequences for the case the N bit sequences are jointly coded, else the UE uses different channel codings for the N bit sequences and does not append any CRC.

Each of FIGS. 6-7 is a logic flow diagram which may be considered to illustrate the operation of a method, and a result of execution of a computer program stored in a computer readable memory, and a specific manner in which components of an electronic device are configured to cause that electronic device to operate. The various blocks shown in each of FIGS. 6-7 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

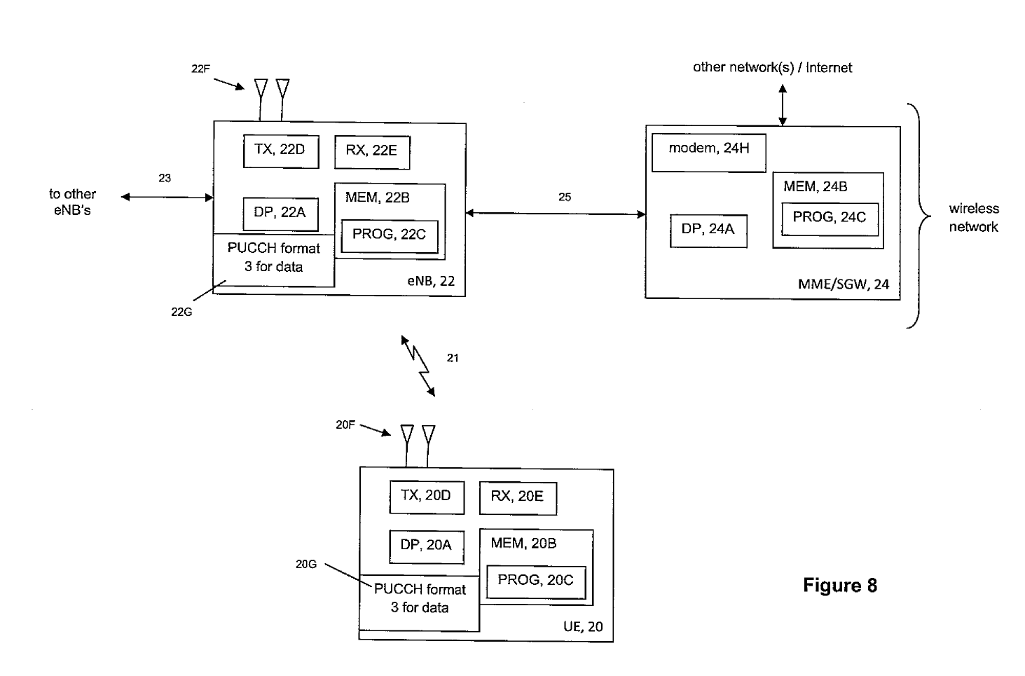

Reference is now made to FIG. 8 for illustrating a simplified block diagram of various electronic devices and apparatus that are suitable for use in practicing the exemplary embodiments of this invention. In FIG. 8 an eNB 22 is adapted for communication over a wireless link 21 with an apparatus, such as a mobile terminal or UE 20. The eNB 22 may be any access node (including frequency selective repeaters) of any wireless network such as LTE, LTE-A, GSM, GERAN, WCDMA, and the like. The operator network of which the eNB 22 is a part may also include a network control element such as a mobility management entity MME and/or serving gateway SGW 24 or radio network controller RNC which provides connectivity with further networks (e.g., a publicly switched telephone network and/or a data communications network/Internet).

The UE 20 includes processing means such as at least one data processor (DP) 20A, storing means such as at least one computer-readable memory (MEM) 20B storing at least one computer program (PROG) 20C or other set of executable instructions, communicating means such as a transmitter TX 20D and a receiver RX 20E for bidirectional wireless communications with the eNB 22 via one or more antennas 20F. Also stored in the MEM 20B at reference number 20G are the rules for how to utilize the PUCCH format 3 (or other predefined UL format) for data as detailed above in the various exemplary embodiments.

The eNB 22 also includes processing means such as at least one data processor (DP) 22A, storing means such as at least one computer-readable memory (MEM) 22B storing at least one computer program (FROG) 22C or other set of executable instructions, and communicating means such as a transmitter TX 22D and a receiver RX 22E for bidirectional wireless communications with the UE 20 via one or more antennas 22F. The eNB 22 stores at block 22G similar rules for how to utilize the PUCCH format 3 (or other predefined UL format) for data as set forth in the various exemplary embodiments above.

While not particularly illustrated for the UE 20 or eNB 22, those devices are also assumed to include as part of their wireless communicating means a modem and/or a chipset which may or may not be inbuilt onto an RF front end chip within those devices 20, 22 and which also operates utilizing the rules and predetermined conditions concerning the second search space according to these teachings.

At least one of the PROGs 20C in the UE 20 is assumed to include a set of program instructions that, when executed by the associated DP 20A, enable the device to operate in accordance with the exemplary embodiments of this invention, as detailed above. The eNB 22 also has software stored in its MEM 22B to implement certain aspects of these teachings. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 8 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances, as well as the machine-to-machine type devices mentioned above.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A system, as noted above the exemplary embodiments of this invention may be used with various other CA-type wireless communication systems.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising:
at least one processor and at least one memory storing a computer program;
in which the at least one memory with the computer program is configured with the at least one processor to cause the apparatus to at least:
configure a user equipment with an integer value N which defines an effective data rate;
send to the user equipment a grant for uplink transmissions, the grant comprising a resource indication field that allocates N channels each having a same predetermined uplink format and payload capacity; and
receive from the user equipment N bit sequences on the respective N channels, each bit sequence comprising data and the same predetermined uplink format.

2. The apparatus according to claim 1, in which the grant is sent when configuring the user equipment with the value N and allocates the N channels to the user equipment for repeated uplink transmissions of data according to a predefined periodicity.

3. The apparatus according to claim 1, in which the grant comprises a predetermined grant format,
and the at least one memory with the computer program is configured with the at least one processor to cause the apparatus, prior to sending to the user equipment the grant, to specifically configure the user equipment to receive at least the predetermined grant format.

4. The apparatus according to claim 3, in which the grant further comprises an indicator for whether or not the allocated N channels are for new data.

5. The apparatus according to claim 4, in which the grant further comprises a modulation and coding scheme indicator identifying modulation and coding the user equipment is to use for the allocated N channels.

6. The apparatus according to claim 3, in which the grant comprises a cyclic redundancy check field which is scrambled by an identifier for the user equipment or for a group of which the user equipment is a member; the predetermined uplink format is a physical uplink control channel format 3; and the apparatus comprises an access node of an E-UTRAN system.

7. The apparatus according to claim 1, in which the N channels are disposed in a same subframe or in adjacent subframes, regardless of the value N configured for the user equipment.

8. The apparatus according to claim 1, in which there is a single medium access control (MAC) header received with the N bit sequences;
and the at least one memory with the computer program is configured with the at least one processor to cause the apparatus to decode the received N bit sequences as a single MAC protocol data unit (PDU).

9. The apparatus according to claim 8, in which;
for the case there is no cyclic redundancy check appended to any of the received N bit sequences, the at least one memory with the computer program is configured with the at least one processor to cause the apparatus to decode the received N bit sequences using different channel codings; and
for the case there is a cyclic redundancy check appended to any of the received N bit sequences, the at least one memory with the computer program is configured with the at least one processor to cause the apparatus to jointly decode the received N bit sequences.

10. A method comprising;
configuring a user equipment with an integer value N which defines an effective data rate;
sending to the user equipment a grant for uplink transmissions, the grant comprising a resource indication field that allocates N channels each having a same predetermined uplink format and payload capacity; and
receiving from the user equipment N bit sequences on the respective N channels, each bit sequence comprising data and the same predetermined uplink format.

11-27. (canceled)

28. An apparatus comprising:
at least one processor and at least one memory storing a computer program; in which the at least one memory with the computer program is configured with the at least one processor to cause the apparatus to at least:
determine a user equipment configuration comprising an integer value N which defines an effective data rate;
receive from a network node a grant for uplink transmissions, the grant comprising a resource indication field that allocates N channels each having a same predetermined uplink format and payload capacity; and
send to the network node on the respective N channels N bit sequences, each bit sequence comprising data and the same predetermined uplink format.

29. The apparatus according to claim 28, in which the grant is received with the user equipment configuration for the value N and allocates the N channels for repeated uplink transmissions of data according to a predefined periodicity indicated in the grant.

30. The apparatus according to claim 28, in which the grant comprises a predetermined grant format,
and the at least one memory with the computer program is configured with the at least one processor to cause the apparatus, prior to receiving the grant, to receive a specific configuration for receiving at least the predetermined grant format.

31. The apparatus according to claim 30, in which the grant further comprises an indicator for whether or not the allocated N channels are for new data.

32. The apparatus according to claim 31, in which the grant further comprises a modulation and coding scheme indicator identifying modulation and coding for use with the data sent on the allocated N channels.

33. The apparatus according to claim 30, in which the grant comprises a cyclic redundancy check field which is scrambled by an identifier for the user equipment or for a group of which the user equipment is a member; the predetermined uplink format is a physical uplink control channel format 3; and the apparatus comprises a user equipment operating in an E-UTRAN system.

34. The apparatus according to claim 28, in which the N channels are disposed in a same subframe or in adjacent subframes, regardless of the value N configured for the user equipment.

35. The apparatus according to claim 28, in which the at least one memory with the computer program is configured with the at least one processor to cause the apparatus to append a single medium access control (MAC) header with the sent N bit sequences which allows the network node to decode the received N bit sequences as a single MAC protocol data unit (PDU).

36. The apparatus according to claim 35, in which the at least one memory with the computer program is configured with the at least one processor to cause the apparatus to:
append a cyclic redundancy check to at least one of the N bit sequences prior to the sending for the case the N bit sequences are jointly coded, else use different channel codings for the N bit sequences and do not append any cyclic redundancy check.

37. The apparatus according to claim 28, in which user equipment configuration for the value N is received via layer 1 signaling separate from the grant.

38-57. (canceled)
